(19) United States
(12) Patent Application Publication
(10) Pub. No.: US 2024/0386371 A1
(43) Pub. Date: Nov. 21, 2024

(54) AUTHENTICATION SYSTEM FOR PACKAGE DELIVERY

(71) Applicant: Taigo YAMAGAMI, Auckland (NZ)

(72) Inventor: Taigo YAMAGAMI, Auckland (NZ)

(21) Appl. No.: 18/320,974

(22) Filed: May 20, 2023

(51) Int. Cl. G06Q 10/083; G06K 19/07

(52) U.S. Cl. CPC G06Q 10/0838; G06K 19/0723

(57) ABSTRACT

A secure container configured to establish a communication with a handler device, extract a first handler identifier associated with the handler device, and prepare and transmit an authentication request based on at least a secure container identifier and the first handler identifier. A server system is configured to receive the authentication request, extract the first handler identifier from the authentication request, retrieve information made available by a delivery company using the first handler identifier, and determine whether to unlock a locking mechanism of the secure container based at least on a comparison of the secure container identifier, the first handler identifier, and the retrieved information. The secure container configured to receive from server system an authentication response, process the authentication response, and unlock at least one locking mechanism to allow the at least one package to be deposited in the at least one receptacle when the authentication message is positive.

### TECHNICAL FIELD OF THE INVENTION

The present invention, in embodiments thereof, generally relates to the field of package delivery. More specifically, the invention is related to systems and methods for efficiently delivering packages to customers, administering access to provide access to customer containers, and preventing unauthorized access to customer containers.

### BACKGROUND OF THE INVENTION

There is a need to provide protection of packages being delivered, throughout the entire process of collection from the supplier to safe delivery to the customer, in particular protection that the package is to be delivered safely, correctly and quickly.

Multiple solutions exist to provide solutions to the aforementioned need, including various forms of delivery systems with differing levels of authentication requirements throughout the entire process of delivery, as discussed prior. The current solutions have one or multiple drawbacks, including at least the potential for the unlocking tag to be stolen/lost without a means of deactivation, slow unlocking and hence slow delivery times, potential for damage to the packages being delivered, unwanted access to the customer's home, and/or defeating the purpose of the delivery.

One such solution exists in the form of a Near Field Communication (NFC) drop box (for example, European Patent No. 3047459) wherein the delivery drivers hold a NFC tag capable of unlocking said NFC drop box. Significant issues can arise as any undesirable obtention of said NFC tag (including said NFC tag being stolen, cloned, or otherwise) can result in the NFC drop box being unlockable by this undesirable person with limited ability to disable said tag.

Another such solution exists in a smart drop box (for example, U.S. Pat. No. 10,817,824) wherein the unlocking time of the drop box can occasionally take longer than desired. Significant issues can arise as said smart drop boxes can be slow to unlock, resulting in significant delays in package delivery times, as well as the potential for delivery drivers to leave packages outside the drop box, in order to save the time having to unlock the drop box, to keep up with delivery deadline requirements.

Another such solution exists in a mechanical drop box wherein the delivery driver drops the package down into a drop box. Significant issues can arise as customers are unlikely to want fragile packages dropped down into a box, with risk of damage. Additionally, the capacity of said drop boxes can be limited relative to its size.

Another such solution exists in at—home delivery (for example Amazon Key) wherein the delivery driver is provided access to a section of the customer's home. Issues can arise in which the customer is uncomfortable allowing the delivery driver to enter their home.

Further such solutions exist in smart lockers (for example Amazon Lockers) and post offices. Issues exist here in that these solutions defeat the purpose of home delivery as the customer is required to go pick up the package themselves.

The aforementioned solutions fall short, as discussed above.

It is an object of the present invention to provide an improved authentication system for package delivery to overcome at least some of the aforementioned issues, or to at least provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### BRIEF DESCRIPTION OF THE INVENTION

In a first aspect of the present invention may be said to broadly consist in a server system for processing authentication requests received from a secure container. The secure container may comprise a locking mechanism, a receptacle and being operative to communicate with a handler device. The system may include at least one processor; at least one interface; at least one memory storing a plurality of instructions. The at least one processor may be operable to execute a plurality of instructions stored in the memory for causing at least one component of the computer network to: receive an authentication request from the secure container, the authentication request comprising a secure container identifier and a first handler identifier associated with the handler device; extract the first handler identifier from the authentication request; retrieve information made available by a delivery company using the first handler identifier; and, determine whether to unlock a locking mechanism of the secure container thereby allowing at least one package to be deposited in a receptacle of the secure container based at least on a comparison of the secure container identifier, the first handler identifier, and the additional information.

Preferably, the at least one processor may be operable to execute a plurality of instructions stored in the memory for causing at least one component of the computer network to retrieve a second handler identifier using the first handler identifier.

Preferably, the at least one processor may be operable to execute a plurality of instructions stored in the memory for causing at least one component of the computer network to retrieve the information made available by the delivery company using the second identifier.

Preferably, the at least one processor may be operable to execute a plurality of instructions stored in the memory for causing at least one component of the computer network to determine whether to unlock the locking mechanism of the secure container based at least on a comparison of the secure container identifier, the second handler identifier, and the additional information.

Preferably, the at least one processor may be operable to execute a plurality of instructions stored in the memory for causing at least one component of the computer network to: prepare an authentication response based on an outcome of the determining step; and, transmit the authentication response to the secure container.

Preferably, no authentication response is transmitted to the secure container when it is determined to not unlock the locking mechanism.

Preferably, the secure container identifier may comprise one or more of: a customer identifier; a customer name; a secure container serial number; and/or one or more address(es).

Preferably, the first handler identifier may comprise: a handler serial number; a handler name; a delivery company serial number; and/or a delivery company name.

Preferably, the second handler identifier may comprise: a handler serial number; a handler name; a delivery company serial number; and/or a delivery company name.

In another aspect of the present invention may be said to broadly consist in a secure container for receiving packages. The secure container may comprise: at least one receptacle for receiving and storing at least one package; at least one locking mechanism; at least one input/output interface operative to communicate with at least a handler device and one or more servers, the input/output interface being configured to transmit an authentication request to the one or more servers; and, one or more hardware processors and hardware memory storing instructions that, when executed by the one or more hardware processors may establish a communication with a handler device; extract a first handler identifier associated with the handler device; prepare the authentication request, the authentication request based on at least a secure container identifier and the first handler identifier; receive an authentication response from the one or more servers, the authentication response may be based at least on a comparison of the secure container identifier, the first handler identifier, and information retrieved using the first handler identifier; processes the authentication response; and, my unlock the at least one locking mechanism to allow the at least one package to be deposited in the at least one receptacle when the authentication message is positive.

Preferably, the secure container identifier may comprise one or more of: a customer identifier; a customer name; a secure container serial number; and/or one or more address(es).

Preferably, the first handler identifier may comprise: a handler serial number; a handler name; a delivery company serial number; and/or a delivery company name.

Preferably, the one or more hardware processors and hardware memory storing instructions that, when executed by the one or more hardware processors may: receive an authentication response from the one or more servers, the authentication response being based at least on a comparison of the secure container identifier, a second handler identifier retrieved using the first handler identifier, and information retrieved using the second handler identifier.

Preferably, the second handler identifier may comprise: a handler serial number; a handler name; a delivery company serial number; and/or a delivery company name.

Preferably, the handler device is an NFC tag and the at least one input/output interface is an NFC tag reader operative to communicate with the NFC tag.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

### BRIEF DESCRIPTION OF THE DRAWINGS

In order that the advantages of the invention will be readily understood, a more particular description of the invention briefly described above will be rendered by reference to specific embodiments illustrated in the appended drawings.

Understanding that these drawings depict only typical embodiments of the invention and are not therefore to be considered limiting of its scope, the invention will be described and explained with additional specificity and detail through use of the accompanying drawings, in which:

FIG. 1 is a simplified block diagram illustration of a system 100 for secure package or parcel delivery, constructed and operative in accordance with embodiments of the present invention;

FIG. 2 is a simplified block diagram illustration of a secure container 210 for use with the system 100 of FIG. 1, constructed and operative in accordance with embodiments of the present invention;

FIG. 3 is a simplified block diagram illustration of one or more cloud servers 350 for use with the system 100 of FIG. 1 and the secure container 210 of FIG. 2, constructed and operative in accordance with embodiments of the present invention;

FIG. 4 is a simplified flow chart diagram of a method implemented at the secure container 110, 210, according to embodiments of the present invention; and,

FIG. 5 is a simplified flow chart diagram of a method implemented at the one or more servers 150, 350, according to embodiments of the present invention.

### DETAILED DESCRIPTION

It will be readily understood that the components of the present invention, as generally described and illustrated in the FIGS. herein, could be arranged and designed in a wide variety of different configurations. Thus, the following more detailed description of the embodiments of the invention, as illustrated in the FIGS., is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge cloud servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. Computer program code for implementing the invention may also be written in a low-level programming language such as assembly language.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, special purpose computer, embedded system, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

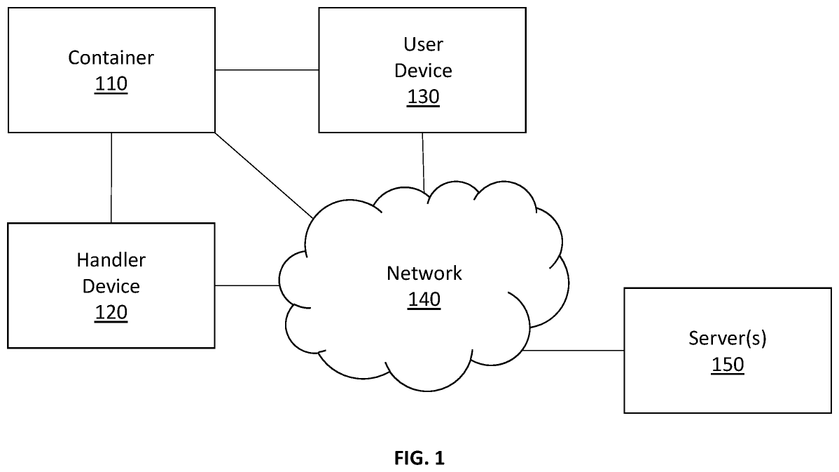

Reference is now made to FIG. 1, which is a simplified block diagram illustration of a system 100 for secure package or parcel delivery, constructed and operative in accordance with embodiments of the present invention.

The system of FIG. 1 includes a secure container 110, a handler device 120, a user device 130, one or more networks 140, one or more cloud servers 150 belonging to or in communication with a merchant or goods provider and/or a delivery company. However, it should be appreciated that one or more of the devices of the system 100 may be omitted in some embodiments. A user or customer may initially place an order or make a purchase for goods with a merchant or provider using the user device 130 via the one or more networks 140. When the customer is placing his order, the provider may gather, store or retrieve information about the customer such as, but not limited to, customer identification, address, payment information, etc. This information can be stored at or retrieved from the one or more cloud servers 150 and, upon receipt of the order, the provider may prepare a package for delivering the goods to the customer. The package is then passed to a shipper/handler of a delivery company for delivery to the user. At the time of completing the order and/or passing the package to the delivery company, information or data associated with the package (e.g., tracking number, package assignment information, etc.) and/or associated with the delivering company or handler (e.g., handler serial number, handler identifier, etc.) may be stored in the one or more cloud servers 150 for later use during a multi-step authentication process. In another embodiment, the user or customer may use the delivery company to deliver a package or parcel to another user or customer. For example, the customer may use his user device 130 to communicate to the delivery company via the one or more networks 140 to have a package or parcel delivered to another customer/another secure container. In this instance, the delivery company may gather, store or retrieve information about the customer such as, but not limited to, customer identification, address, payment information, etc. This information can be stored in the one or more cloud servers 150 and for later use during a multi-step authentication process.

The handler is then in charge of delivering the package to the container 110 associated with the user or user device 130. Upon arrival at the user's location, the handler device 120 may be used by the handler to open the secure container 110. Opening of the secure container 110 is allowed upon completion of the multi-steps authentication process. In a first step, the secure container 110 may communicate with the handler device 120 to validate and retrieve the information or data associated with the delivering company or handler. In a second step, the secure container 110 may communicate with or transmit a request to the one or more cloud servers 150 via the one or more networks 140 to determine whether the handler has a package assigned to him for delivery at the secure container 110. If authentication is successful, the secure container 110 may receive a confirmation message and allow the handler to unlock or open the container to leave the package. Further information or data may be used during this multi-step authentication process as will be described in further details hereinbelow.

The customer or user may then unlock and open the secure container 110 to retrieve and/or deposit the package from the secure container 110 using the user device 130 or a separate tag, a key-code input, or otherwise. In an embodiment, the secure container 110 comprises a key-code input for unlocking the locking mechanism, such that the security of the package receptacle can be increased as the receptacle is not prone to lockpicking, or other forms of breaching the receptacle. Additional security features may also be implemented into the secure container 110 including, but not limited to, a security camera system, a visual and/or audial alert if the receptacle has not been closed correctly, or otherwise.

The user device 130 and the handler device 120 may be, for example, but without limiting the generality of the present invention, a laptop computer, a desktop or personal computer (PC), a tablet computer such as an iPad™, a mobile computing device, such as a Personal Digital Assistant (PDA), mobile phone, or any other suitable handheld device. The user device 130 and handler device 120 can typically comprise a rendering screen, a video player, a memory, a storage unit, a processor and a communications unit. It is appreciated that these devices comprise standard hardware and software components as is well known in the art. Alternatively, the handler device 120 may be an electronic tag allowing the handler to access the secure container 110. In addition, the handler device 120 or a vehicle associated with the handler may be used to provide geolocation information (e.g. Global Positioning System coordinates) in real-time that can be used during the multi-steps authentication process.

The secure container 110 and one or more cloud servers 150 of the system 100 will be described in more details hereinbelow.

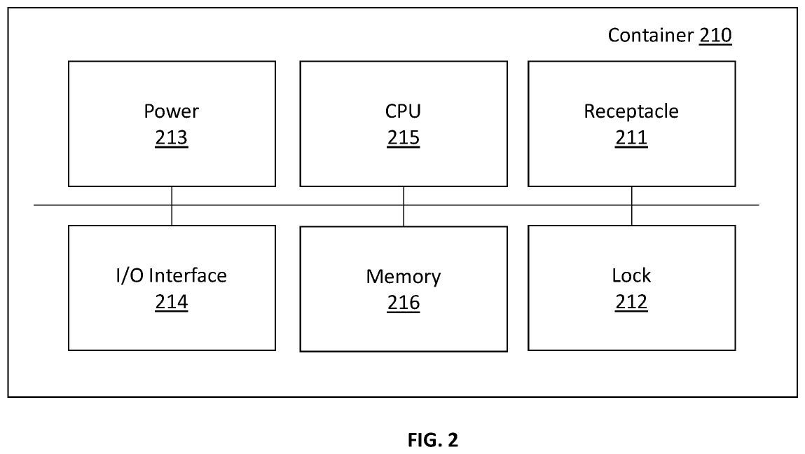

Reference is now made to FIG. 2, which is a simplified block diagram illustration of a secure container 210 for use with the system 100 of FIG. 1, constructed and operative in accordance with embodiments of the present invention.

The secured container 210 includes at least one receptacle 211, at least one lock 212, a power unit 213, at least an input/output (I/O) interface 214, a processor 215 and a memory 216.

The at least one receptacle or internal compartment 211 can receive packages for personal and/or commercial use. The receptacle can be shaped and sized accordingly to suit the user, the type of packages to be received, or otherwise. It is to be understood that the secure container 210 could also comprise a variety of additional features either aesthetic and/or functional, to suit the user. That is, the secure container 210 can be designed to suit the environment with which it is to be located, either indoors, outdoors, hot weather, cold weather, or otherwise. In an embodiment, the secure container 210 will be made of durable materials capable of protecting the package from the external environment, such that the receptacle or internal compartment remains dry and sheltered, both before and after receiving the package.

The I/O interface 214 may be any suitable communication interface enabling the secure container 210 to communicate and exchange data with one of more of the following: the user device 130, the handler device 120, the one or more cloud servers 150 and/or the customer. The I/O interface 214 is further operable to pass the received data to the processor 215 and/or the memory 216. As shown in FIG. 1, the secure container 110, 210 can communicate with the different elements of the system 100. In particular, the I/O interface 214 allows the secure container 210 to communicate with the handler device 120 using any suitable technology. The I/O interface 214 may comprise communication circuitry configured to use any one or more wired and/or wireless communication technologies and associated protocols. For example, in some embodiments, the secure container 210 may be configured to communicate with the handler device 120 via a wired communication (e.g., Ethernet), Wi-Fi (e.g., infrastructure or ad hoc mode), Wi-Fi Direct, Bluetooth (including Bluetooth Low Energy (BLE)), Zigbee, Z-wave, Near Field Communication (NFC), IEEE 802.15, Radio-Frequency Identification (RFID), and/or other suitable wireless communication protocol(s). The I/O interface 214 is also configured to allow the secure container 210 to communicate with the user device 130, directly or via the one or more networks 140, to allow the user or customer to retrieve the package once delivered. The communication technologies or protocols described hereinabove can be used. In an embodiment, the customer or user may also be supplied with a “master NFC tag” or equivalent for use with the I/O interface 214 configured as or comprising an NFC tag reader. Upon communication of the master NFC tag with the NFC tag reader, the secure container 110 can be unlocked/opened by the customer using or without a multi-step authentication process. In addition, or alternatively, the I/O interface 214 can communicate with the user via a key-code input, or otherwise. Lastly, The I/O interface 214 can communicate with the one or more cloud servers 150 via the one or more networks 140 to implement/perform the multi-steps authentication process that will described in further details hereinbelow.

The processor or computer processing unit 215 can be any suitable processor, such as, but not limited to, a microcontroller or a microprocessor, for example to execute software instructions stored in memory 216.

The memory 216 may comprise read only memory (ROM), random access memory (RAM), magnetic disk storage media devices, optical storage media devices, flash memory devices, electrical, optical, or other physical/tangible (e.g. non-transitory) memory storage devices. Thus, in general, memory 216 may comprise one or more computer readable storage media (e.g. memory device) encoded with software comprising computer executable instructions and when the software is executed (by the processor 215) it is operable to perform the operations described hereinbelow. For example, memory 216 stores or is encoded with instructions for at least:
Validating and retrieving the information or data associated with the handler/delivery company, handler, or any other suitable information or data upon communication with the handler device 120;
preparing authentication requests to be transmitted to the one or more cloud servers 150 via the one or more networks 140 to determine whether the handler has a package assigned to him for delivery at the secure container 210; and,
processing authentication responses received from the one or more cloud servers 150; and/or,
unlocking or opening the container 210 to allow access to the package. Further information or data may be used during this multi-step authentication process as will be described in further details hereinbelow.

The power unit 213 may be any type of power source allowing the different elements of the secure container 210 to powered whenever required. The power unit 213 can be completely energetically self-sufficient or connected to external power supply, if necessary. The power unit 213 may include, for example, but not limited to, rechargeable batteries, solar cells or some other means for generating power without external power supply, or any other type of battery capable for providing operation voltage. In some embodiments, the secure container 210 may be fed with electric power from a separate device so that the secure container 210 does not comprise a power source.

The secure container 210 may comprise at least one receptacle or internal compartment 211 capable of receiving packages for personal and/or commercial use. The receptacle 211 can be shaped and sized accordingly to suit the user, the type of packages to be received, or otherwise. It is to be understood that the secure container 210 could also comprise a variety of additional features either aesthetic and/or functional, to suit the user. That is, the secure container 210 can be designed to suit the environment with which it is to be located, either indoors, outdoors, hot weather, cold weather, or otherwise. In an embodiment, the secure container 210 will be made of durable materials capable of protecting the package from the external environment, such that the receptacle or internal compartment remains dry and sheltered, both before and after receiving the package.

The secure container 210 may comprise a lock or lock mechanism 212. The locking mechanism 212 can be an electronic lock which can be unlocked by the processor 215 after the multi-steps authentication process and/or identification of the user device 130 and/or a successful key-code input.

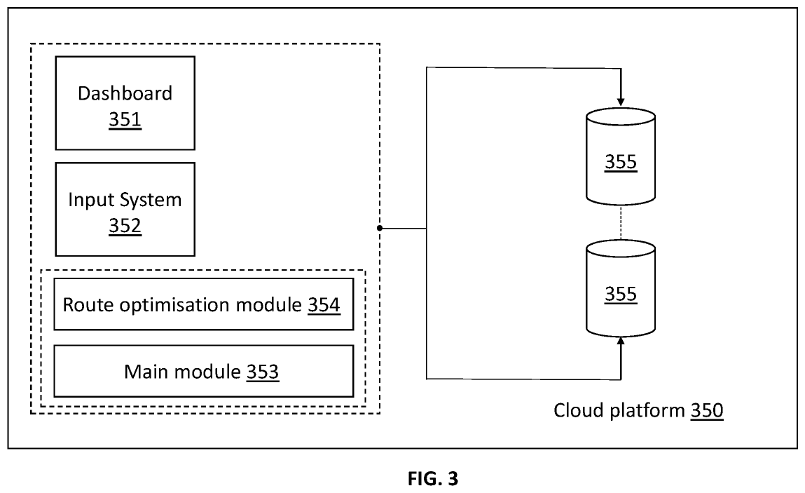

Reference is now made to FIG. 3, which is a simplified block diagram illustration of one or more cloud servers 350 for use with the system 100 of FIG. 1 and the secure container 210 of FIG. 2, constructed and operative in accordance with embodiments of the present invention.

FIG. 3 illustrates a back-end software solution residing on a server system. This back-end solution defines a cloud platform 350 which control the entire operations and ensure communications between the customer/user device 130, the secure container 110, 210, the delivery company and handler device 120, and the merchant. The cloud platform 350 is formed by software and hardware components that are configured to interact between each other and may comprise: a dashboard 351, an input system 352, a main module 353, a route optimisation module 354 and one or more databases 355. Although the dashboard 351, the input system 352, the main module 353, the route optimisation module 354 and the one or more databases 355 are described as separate components, those skilled in the art would understand that these components could be integrated into a single component. Also, those skilled in the art would understand that not all components are required for implementing the solution and that some of them could be omitted and/or combined with other components.

To start using the secure delivery services provided by the system 100, a customer can connect to the cloud platform 350 and register via the input system 352 using, e.g., his user device 130. During registration, the customer will be asked to submit personal information and data, as well as information and data associated to his secure container 110, 210. For example, but limited to, the customer can provide a customer identifier, a customer address, an address for the secure container and a secure container identifier or serial number. Upon completion of the registration process, the system 352 can collect the submitted information and stored them in one the databases 355 for future use.

Similarly, to start using the secure delivery services provided by the system 100, delivery companies and/or merchant can connect and register to the cloud platform 350. Upon registration, the participating delivery companies can be assigned a specific portal or dashboard 351. This specific dashboard 351 can provide a plurality of services or functionalities to the delivery company such as, but not limited to:
issuance and enrolment: for example, a specific identifier or serial number can be assigned to a handler or handler device 120 (e.g., handler ID, handler name, etc.);
management of the handler device 120;
access control management to, e.g., activate or disable handler device 120;
transaction processing and reporting of the different delivery transactions. This can allow keeping track of logs and scans performed by the handlers;
system monitoring and maintenance;
auto-deactivation when a handler device 120 is suspicious (e.g., multiple failed or denied attempts to open a secure container 110, 210);
alert system for a suspicious behaviour and options to continue allowing the handler device 120 to unlock secure containers if justified (e.g., multiple secure containers at the delivery site);
name matching feature to allow data reconciliation or consolidation; and,
alert when geolocation information associated with the handler device 120 or handler's vehicle is not in the vicinity of the address which the package is due to be delivered.

The relevant data can then be stored and indexed in the database(s) 355 for future use.

The route optimisation module 354 is a piece of software that is typically used by delivering companies to track “last-mile” delivery information such as a package assignment to a handler and the address where the package needs to be delivered. This module 354 can optimize delivery routes and assign packages to handlers based on various factors such as, but not limited to, delivery location, handler availability, package size, etc. The route optimisation module 354 can be any form of delivery software, as required. That is, the route optimisation module can be a courier dispatch software, or otherwise, that provides the necessary delivery information as detailed above. This software module 354 may be integrated to the main software module 353 or can be a standalone module.

The main module 353 is programmed to manage and perform the multi-steps authentication process by communicating with from the different elements of the system 100 and access, interrogate, extract and/or retrieve data, and process data from the databases 355 and the route optimisation module 354.

The functioning of the route optimisation module 354 and main module 353 will be described in more details below. In addition, those skilled in the art would understand that, although these modules are described as software components, they can equally be implemented in hardware components.

It should be appreciated that the one or more cloud servers or cloud platform 150, 350 may be embodied as a computing device including at least one interface, at least one processing device and at least one memory having stored thereon operating logic for execution by the processing device for operation of the corresponding device.

It should be further appreciated that, although one or more cloud servers or cloud platform 150, 350 are described herein as cloud-based devices or collections of devices, in other embodiments, each element 351, 352, 353 and 354 of the cloud platform 150, 350 may be embodied as one or more devices outside of a cloud computing environment. Further, in some embodiments, each element 351, 352, 353 and 354 of the cloud platform 150, 550 and the cloud platform 150, 350 itself may be embodied as a “serverless” or server-ambiguous computing solution, for example, that executes a plurality of instructions on-demand, contains logic to execute instructions only when prompted by a particular activity/trigger, and does not consume computing resources when not in use. That is, the elements 351, 352, 353 and 354, and the cloud platform 150, 350 may be embodied as a virtual computing environment residing “on” a computing system (e.g., a distributed network of devices) in which various virtual functions (e.g., Lamba functions, Azure functions, Google cloud functions, and/or other suitable virtual functions) may be executed corresponding with the functions of the cloud server 106 and/or the service cloud server 112 described herein.

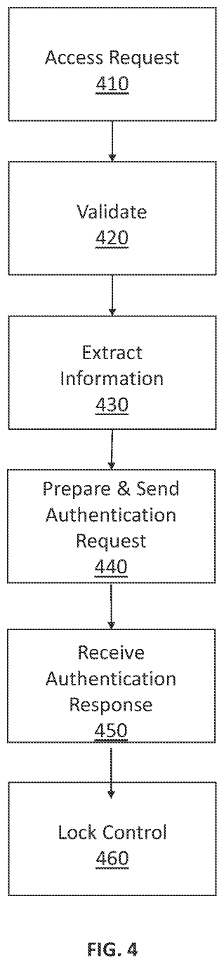

Reference is now made to FIG. 4, which is a flow chart diagram of a method implemented at the secure container 110, 210, according to embodiments of the present invention.

At step 410, a handler or handler device 120 requires access to the secure container 110 to deliver a package. This can be achieved by having the I/O interface 214 of the secure container 210 detecting that the handler device 120 is establishing a communication sequence in order to validate and/or obtain the information or data contained on the handler device 120. In an embodiment, the I/O interface 214 comprises an NFC tag reader and the handler device 120 is an NFC tag assigned to the handler. In this embodiment, communication can be established when the NFC tag is within range of the NFC tag reader of the secure container 210.

At step 420, the secure container 210 can validate the handler device 120. This can be achieved by using cryptographic functionality provided at the secure container 210. For example, the memory 216 can comprise a cryptographic key or signature allowing the processor 215 to decode and access the information or data stored on the handler device 120. Those skilled in the art would understand that any encoding or decoding mechanisms could be used for validating this communication, for example, but not limited to, using a public key cipher like RSA, a keyed hash function, a hash function whose result is signed by a public key cipher, or a symmetric key cipher such as AES. If the I/O interface 214 determines handler device 120 is not valid, the attempt will be deemed a denied attempt and the process stops.

Upon successful validation at step 420, the process can move to stop 430 at which the processor 215 of the secure container 210 extracts the decoded information or data from the handler device 120. In an embodiment, the extracted data includes data identifying a handler, handler device 120, and/or a delivery company. This data can include for example, but not limited to, one or more of the following: an identifier or serial number associated with the handler, an identifier or serial number associated with the handler device 120, and/or an identifier or serial number associated with the delivery company.

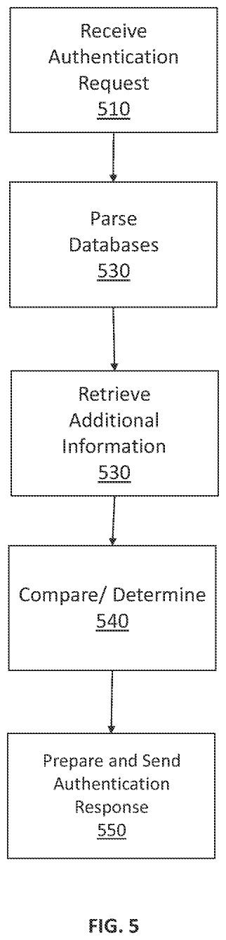

At step 440, an authentication request comprising the extracted data is prepared by the processor 215 alongside with data associated with the secure container 210. This data can include for example, but not limited to, one of more of the following: a customer identifier, a secure container identifier or serial number, and/or a customer address. The authentication request is sent by the I/O interface 214 to the one or more cloud servers 150 and can then be processed by the cloud platform, in particular, by the main module 353 to determine whether the handler has a package assigned to him for delivery at the secure container 210. Details of how the authentication request is processed by the main module 353 will be described hereinbelow in relation to FIG. 5.

Once the request is processed by the main module 353, the secure container 210 receives an authentication response from the cloud platform 350. The authentication response is received by the I/O interface 214 and processed by the processor 215.

The process then moves to step 460 where the processor 215 controls the lock 212 depending on the received message. If the received authentication response indicates that the multi-steps authentication process has been successful, the processor 215 proceeds to deactivate the lock 212 thereby allowing the handler to leave the package in the receptacle 211. If, however, the received authentication response indicates that the multi-steps authentication process has been unsuccessful, the processor 215 keeps the lock 212 activated, does not open the container 210 and the process ends. In addition, or alternatively, the system may be set-up such that the secure container 210 and the I/O interface 214 does not receive an authentication message from the one or more servers 150. In this situation, the processor 215 would deem the authentication request unsuccessful (e.g., after expiry of a timer and/or after a pre-determined duration). The processor 215 keeps the lock 212 activated, does not open the container 210 and the process ends.

Reference is now made to FIG. 5, which is a flow chart diagram of a method implemented at the main module 353 of the cloud platform 350, according to embodiments of the present invention.

The process starts at step 510 at which the main module 353 receives an authentication request from a secure container 110, 210. As indicated hereinabove, the authentication request comprises data identifying a handler, handler device 120, and/or a delivery company, and data associated with the secure container 210. The data received by the main module 353 can then be processed by the main module 353.

At step 520, the main module 353 extracts the data received as part of the authentication message. Once extracted, the main module 353 parses or scans the database 355 comprising data relevant to customers using the data associated with the secure container 210. For example, the identifier or serial number associated with the customer or secure container 110, 210 can be used to confirm that the customer is registered. This customer verification step can be optional and not performed by the main module 353 in some embodiments. The main module 353 parses or scans the database 355 using the data identifying a handler, handler device 120, and/or a delivery company to identify and retrieve a second set of identifying data for the handler and/or handler device 120 as provided by delivery companies. For example, but not limited to, a first identifier or serial number associated with the handler and received as part of the authentication message can be used to identify and retrieve a second identifier or serial number associated with the specific handler.

Optionally, if the main module 353 cannot find the second set of identifying data associated with the handler or handler device 120 in the database 355, the process moves to step 540. A negative authentication response is prepared and transmitted back to the secure container 110, 210 at step 550. Alternatively, step 550 can be omitted and, if the main module 353 cannot find the second set of identifying data associated with the handler or handler device 120 in the database 355, no authentication response is transmitted to the secure container 110, 210.

Alternatively, if the main module 353 cannot find the second set of identifying data, the process can still move to step 530. Here, the data identifying a handler, handler device 120, and/or a delivery company can be used within step 530, as described below.

If the main modules 353 identifies the second set of identifying data identifier or a serial number associated with the handler or handler device 120, the process moves to step 530. At step 530, the main module 353 uses the retrieved second set of identifying data associated with the handler or handler device 120, if identified, or the data identifying a handler, handler device 120, and/or a delivery company, if the second set of identifying data was not identified, to retrieve additional information or data from the route optimisation module 354 or any other relevant database or software component. The additional information can comprise, for example, but not limited to: package assignment information; package delivery address; current geolocation data of the handler device 120 or vehicle associated with the handler; whether the route optimisation module 354 is currently routing the handler to the package delivery address; etc.

At step 540, this additional information can then be compared to the information or data provided in the authentication request to determine whether a specific handler or handler device 120 has a package assigned to him for delivery at the specific address where a secure container 110-handler device 120 interaction recently occurred.

In an exemplary embodiment, the authentication message received by the main module 353 comprises a secure container identifier (e.g., address, customer identifier, secure container serial number, etc.) and a first handler identifier (e.g., handler device serial number, handler serial number, handler name, etc). The main module 353 extracts the first handler identifier to retrieve a second handler identifier from the databases. For example, the first handler identifier can be a serial number associated with the handler device and the retrieved second identifier can be a handler name. Those skilled in the art would appreciate that the second handler identifier can be any type of identifier (e.g., handler device serial number, handler serial number, handler name, etc.) allowing the main module to retrieve additional information from the route optimisation module 354 or any other database. The main module 353 can then scan the route optimisation module 354 and retrieve the additional information using the handler's name.

For example, the retrieved additional information can comprise package assignment information thereby confirming that the handler has a package for delivery to the customer or secure container.

The additional information can also comprise a package address. This address can then be compared to the secure container identifier. For example, the package address can be compared to the customer address provided as part of the secure container identifier. If the secure container identifier does not comprise the customer address, the main module 353 can use other information provided as part of the secure container identifier (e.g., secure container serial number, customer identifier, etc.) to retrieve the customer address from the input system 352 and/or a database 355 associated with the input system 352. In another example, the additional information can comprise GPS or another type of geolocation data associated with the handler's vehicle or device 120. Again, it can be compared to the customer address provided as part of the secure container identifier or retrieved from the input system 352 and/or a database 355 associated with the input system 352.

Those skilled in the art will appreciate that the secure container identifier, the first handler identifier and the second handler identifier are provided as examples only and that other identifiers could be used.

The process moves to step 550 at which the main module 353 prepares a positive or negative authentication response indicating whether the multi-steps authentication process has been successful. The main module 353 then transmits the positive or negative to the secure container 110, 210 at step 550 and the process ends. Alternatively, and as indicated hereinabove, step 550 can be omitted and no authentication response (instead of a negative authentication response) is transmitted to the secure container 110, 210.

Although only one secure container 110, 210, one user device 130, one cloud platform 150, 350, and one handler device 120 are shown in the illustrative embodiment of FIG. 1, the system 100 may include multiple secure containers 110, 210, user devices 130, cloud platforms 150, 350, and handler devices 120 in other embodiments. For example, as described herein, a particular customer may have multiple user devices 120 that the customer may use to securely connect with the cloud platform 150 in order to register a secure container 110. Similarly, a handler with permission to access/control a particular secure container 110 may securely connect with the cloud platform 150 via any suitable handler device 120 to request and receive access to another secure container. Further, in some embodiments, a particular customer and/or handler may have access to multiple secure containers 110.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

It will be appreciated by persons skilled in the art that the present invention is not limited by what has been particularly shown and described hereinabove. Rather the scope of the invention is defined by the appended claims and equivalents thereof:

1. A server system for processing authentication requests to allow access to a secure container, the system comprising:
at least one processor;
at least one interface;
at least one memory storing a plurality of instructions;
the at least one processor being operable to execute a plurality of instructions stored in the memory for causing at least one component of the computer network to:
receive an authentication request, the authentication request comprising at least a first handler identifier associated with a handler device operative to communicate with the secure container;
extract the first handler identifier from the authentication request;
retrieve information made available by a delivery company using the first handler identifier; and,
determine whether to unlock a locking mechanism of the secure container thereby allowing at least one package to be deposited in a receptacle of the secure container based at least on a comparison of, the first handler identifier, and the retrieved information.

2. The server system of claim 1, wherein the at least one processor is operable to execute a plurality of instructions stored in the memory for causing at least one component of the computer network to retrieve a second handler identifier using the first handler identifier.

3. The server system of claim 2, wherein the at least one processor is operable to execute a plurality of instructions stored in the memory for causing at least one component of the computer network to retrieve the information made available by the delivery company using the second identifier.

4. The server system of claim 3, wherein the at least one processor is operable to execute a plurality of instructions stored in the memory for causing at least one component of the computer network to determine whether to unlock the locking mechanism of the secure container based at least on a comparison of the second handler identifier, and the retrieved information.

5. The server system of claim 1, wherein the at least one processor is operable to execute a plurality of instructions stored in the memory for causing at least one component of the computer network to:
prepare an authentication response based on an outcome of the determining step; and,
transmit the authentication response.

6. The server system of claim 1, wherein no authentication response is transmitted when it is determined to not unlock the locking mechanism or an authentication response indicating to not unlock the locking mechanism is transmitted.

7. The server system of claim 16, wherein the secure container identifier comprises one or more of: a customer identifier; a customer name; a secure container serial number; and/or one or more address(es).

8. The server system of claim 1, wherein the first handler identifier comprises one or more of: a handler serial number; a handler name; a delivery company serial number; and/or a delivery company name.

9. The server system of claim 2, wherein the second handler identifier comprises one or more of: a handler serial number; a handler name; a delivery company serial number; and/or a delivery company name.

10. A secure container for receiving packages comprising:
at least one receptacle for receiving and storing at least one package;
at least one locking mechanism;
at least one input/output interface operative to communicate with at least a handler device; and,
one or more hardware processors and hardware memory storing instructions that, when executed by the one or more hardware processors:
establishes a communication with a handler device;
and,
determine whether to unlocks the at least one locking mechanism to allow the at least one package to be deposited in the at least one receptacle when an authentication response is positive, the authentication response being based at least on a comparison of a first handler identifier associated with the handler device and information made available by a delivery company retrieved using the first handler identifier.

11. The secure container of claim 18, wherein the secure container identifier comprises one or more of: a customer identifier; a customer name; a secure container serial number; and/or one or more address(es).

12. The secure container of claim 10, wherein the first handler identifier comprises one or more of: a handler serial number; a handler name; a delivery company serial number; and/or a delivery company name.

13. The secure container of claim 10, wherein the one or more hardware processors and hardware memory storing instructions that, when executed by the one or more hardware processors: determines whether to unlock the at least one locking mechanism when the authentication response is positive, the authentication response being based at least on a comparison of a second handler identifier retrieved using the first handler identifier, and information made available by a delivery company retrieved using the second handler identifier.

14. The secure container of claim 13, wherein the second handler identifier comprises one or more of: a handler serial number; a handler name; a delivery company serial number; and/or a delivery company name.

15. The secure container of claim 10, wherein the handler device and the at least one input/output interface are configured to communicate wirelessly.

16. The server system of claim 1, wherein the authentication request comprises a secure container identifier and wherein the at least one processor is operable to execute a plurality of instructions stored in the memory for causing at least one component of the computer network to:
receive the authentication request from the secure container; and,
determine whether to unlock the locking mechanism of the secure container based at least on a comparison of the secure container identified, the first handler identifier, and the retrieved information.

17. The server system of claim 3, wherein the at least one processor is operable to execute a plurality of instructions stored in the memory for causing at least one component of the computer network to determine whether to unlock the locking mechanism of the secure container based at least on a comparison of a secure container identifier, the second handler identifier, and the retrieved information.

18. The secure container of claim 10, wherein:
the at least one input/output interface is operative to communicate with one or more servers; and
the one or more hardware processors and hardware memory storing instructions that, when executed by the one or more hardware processors:
prepares and transmits an authentication request to the one or more servers; and,
determines whether to unlock the at least one locking mechanism when the authentication response is positive, the authentication response being based at least on a comparison of a secure container identifier, the first handler identifier, and the retrieved information.

19. The secure container of claim 10, wherein the one or more hardware processors and hardware memory storing instructions that, when executed by the one or more hardware processors: determines whether to unlock the at least one locking mechanism when the authentication response is positive, the authentication response being based at least on a comparison of a secure container identifier, a second handler retrieved using the first handler identifier, and information made available by a delivery company retrieved using the second handler identifier.

20. The secure container of claim 19, wherein the second handler identifier comprises one or more of: a handler serial number; a handler name; a delivery company serial number; and/or a delivery company name.
